(19) United States
(12) Patent Application Publication
(10) Pub. No.: US 2012/0101917 A1
(43) Pub. Date: Apr. 26, 2012

(54) BUSINESS MOBILE COMMUNICATION SYSTEM

(76) Inventor: Chung-Shu JEN, Hsinchu City (TW)

(21) Appl. No.: 13/252,020

(22) Filed: Oct. 3, 2011

(30) Foreign Application Priority Data
Oct. 22, 2010 (TW) 099136194

(51) Int. Cl. G06Q 30/00

(52) U.S. Cl. 705/26.61; 705/26.1; 705/26.8

(57) ABSTRACT

A business mobile communication system includes a transaction platform, a plurality of client-end users, at least one digital content sever, a communication network, the Internet, and a plurality of mobile communication devices. Each client-end user can operate the corresponding mobile communication device in a dialing number method mode and thereby connect the mobile communication device to the transaction platform through the communication network. Once authorized by the transaction platform, the client-end user can further connect the mobile communication device to any of the at least one digital content server via the Internet by way of the corresponding content index in the transaction platform, so as to access a specific digital content. The specific digital content is transmitted to the client-end user's mobile communication device via a point-to-point transfer protocol.

### BACKGROUND OF THE INVENTION

1. Technical Field

The present invention relates to the field of mobile commerce and, more particularly, to a business mobile communication system configured for dialing merchant's number.

2. Description of Related Art

Nowadays, the most common modes of mobile commerce are based on the Wireless Application Protocol (WAP), the Short Message Service (SMS), connection between mobile phone browsers and merchants' websites, and application programs developed by the merchants themselves. Nevertheless, all these conventional modes of mobile commerce have their inconveniences. For example, WAP-based mobile commerce relies on the services of telecommunications carriers. More specifically, the carriers provide fixed lists to be browsed by users in search for the desired services or products. As the service platform is provided by the carriers, the carriers must charge the merchants for the use of the platform. Also, the service platform has limited space and therefore can only support the services of a limited number of merchants. In SMS-based mobile commerce, on the other hand, a merchant sends short messages (e.g., advertisements) to its clients by software, notifying the clients of discounts, special offers, or like privileged events, and one who receives the short messages can take part in the privileged events using the phone number to which the short messages are sent. At the same phone number, the client may also receive links to software download sites. Therefore, those who wish to carry out SMS-based mobile commerce transactions are still required to rent phone numbers from telecommunications carriers. Besides, short messages contain only text but no graphical interfaces that allow intuitive and convenient operation. Alternatively, if a consumer decides to use a mobile phone to connect to a merchant's website by himself or herself and browse the related commercial information, not only must the consumer know the website address, but also the merchant has to be staffed for timely maintenance or correction of the information on the website. It also takes considerable time for the consumer to download the huge amount of text and graphical data from the website to the mobile phone. Further, if a merchant develops its own mobile commerce software, it is necessary for consumers to download the software to their mobile phones. However, such software is difficult to modify, once downloaded to the client end. Moreover, given the limited storage space in mobile phones, it is impossible for a consumer to store the mobile commerce software of a plurality of merchants. Last but not least, software development is quite costly.

Due to the aforesaid problems of the conventional modes of mobile commerce, a mobile commerce system which is easy to operate and low-cost and which allows merchants to update service information in a timely manner is much desired.

### BRIEF SUMMARY OF THE INVENTION

To overcome the problems mentioned above, the present invention provides a business mobile communication system which includes a transaction platform, a plurality of client-end users, and at least one digital content server. The business mobile communication system further includes a communication network, the Internet, and a plurality of mobile communication devices for use by the client-end users respectively. Each digital content server includes multiple commerce-related digital contents. The transaction platform includes a plurality of content indices to the digital contents. The communication network connects the transaction platform and each of the mobile communication devices, while the Internet connects the transaction platform and each digital content server. Each client-end user can operate the corresponding mobile communication device in a dialing number method to connect the mobile communication device to the transaction platform via the communication network. Once authorized by the transaction platform, the client-end user can further connect the mobile communication device to any of the at least one digital content server via the Internet by way of the corresponding content index in the transaction platform, with a view to accessing a specific digital content. The specific digital content is transmitted to the client-end user's mobile communication device via a point-to-point transfer protocol.

Therefore, it is the primary object of the present invention to provide a business mobile communication system in which a client-end user can directly connect to a merchant's digital content server by dialing merchant's number, without having to input the merchant's website address or take time waiting for webpage transfer to be completed.

It is another object of the present invention to provide a business mobile communication system in which a merchant can directly modify service information on its digital content server, thereby enabling timely modification and maintenance of the service information.

Still another object of the present invention is to provide a business mobile communication system in which digital content servers are accessible through a transaction platform, thus eliminating the need for merchants to develop their own application software and for consumers to download the application software developed by each merchant. Consequently, convenience of use of the system is achieved.

### BRIEF DESCRIPTION OF THE SEVERAL VIEWS OF THE DRAWINGS

A detailed description of further features and advantages of the present invention is given below with reference to the accompanying drawings, in which:

FIG. 1 is a block diagram showing the main structure of a business mobile communication system according to the present invention;

FIG. 2 is another block diagram showing the main structure of the business mobile communication system according to the present invention, wherein the system further includes other modules;

FIG. 3 is the flowchart of an operation process according to a first embodiment of the present invention; and

FIG. 4 is the flowchart of an operation process according to a second embodiment of the present invention.

### DETAILED DESCRIPTION OF THE INVENTION

The present invention discloses a business mobile communication system to which the principles of signal transmission through a communication network apply. As these principles are well known to a person of ordinary skill in the art, a detailed description of the principles is omitted herein. Besides, it should be noted that the drawings referred to in the following description are not drawn according to actual dimensions and need not be so because they are intended to demonstrate the features of the present invention only schematically.

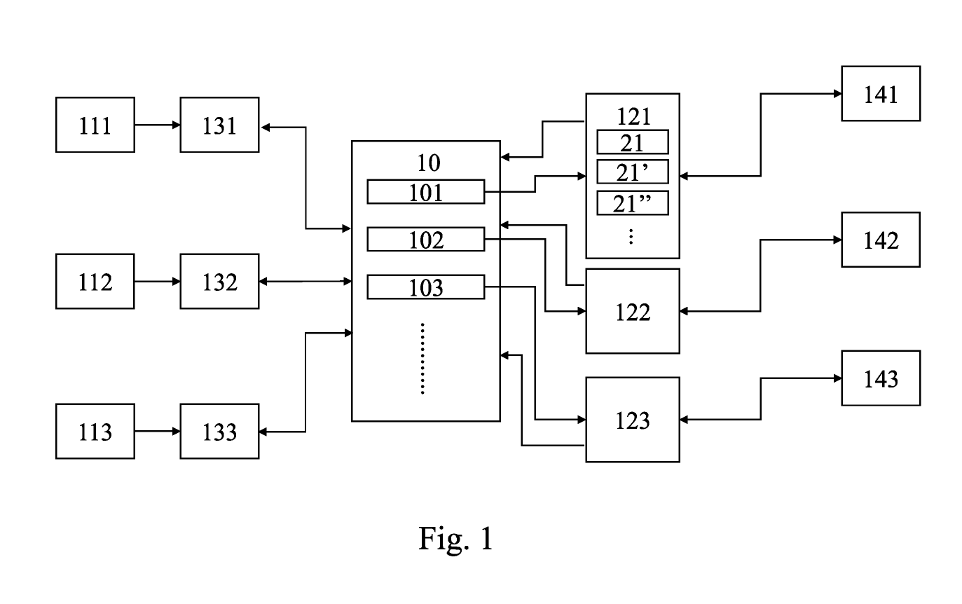

Referring to FIG. 1, a business mobile communication system according to the present invention includes a transaction platform 10; a plurality of client-end users 111, 112, 113; and at least one digital content server. In this embodiment, there are a plurality of digital content servers, namely digital content servers 121, 122, 123. The business mobile communication system further includes a communication network, the Internet, and a plurality of mobile communication devices 131, 132, 133. The mobile communication devices 131, 132, 133, which are provided for use by the client-end users 111, 112, 113, respectively, can be mobile phones or other electronic devices configured for making phone calls via the communication network. Each digital content server 121, 122, 123 includes multiple commerce-related digital contents. For instance, the digital content server 121 includes multiple digital contents 21, 21′, 21″. The transaction platform 10 includes content indices 101, 102, 103 which correspond to the digital content servers 121, 122, 123, respectively. The transaction platform 10 is connected to each mobile communication device 131, 132, 133 by the communication network, and to each digital content server 121, 122, 123 by the Internet. Each client-end user 111, 112, 113 can operate the corresponding mobile communication device 131, 132, 133 in a dialing number method and thereby connect the mobile communication device 131, 132, 133 to the transaction platform 10 via the communication network. Once authorized by the transaction platform 10, the client-end user 111, 112, 113 can select the desired services or products from the content indices 101, 102, 103 in the transaction platform 10 and then, by way of the transaction platform 10 and the Internet, connect the mobile communication device 131, 132, 133 to the digital content server 121, 122, 123 (say 121) that provides the desired services or products. Thus, the client-end user 111, 112, 113 is allowed access to the digital contents 21, 21′, 21″ in this specific digital content server 121 (say 122 or 123), and the digital contents 21, 21′, 21″ are transmitted to the client-end user 111, 112, 113′s mobile communication device 131, 132, 133 via a point-to-point (P2P) transfer protocol.

The business mobile communication system disclosed in the present invention further includes a plurality of client-end merchants 141, 142, 143. The client-end merchants 141, 142, 143 correspond to the digital content servers 121, 122, 123, respectively, and provide the product- or service-related digital contents in the corresponding digital content servers 121, 122, 123.

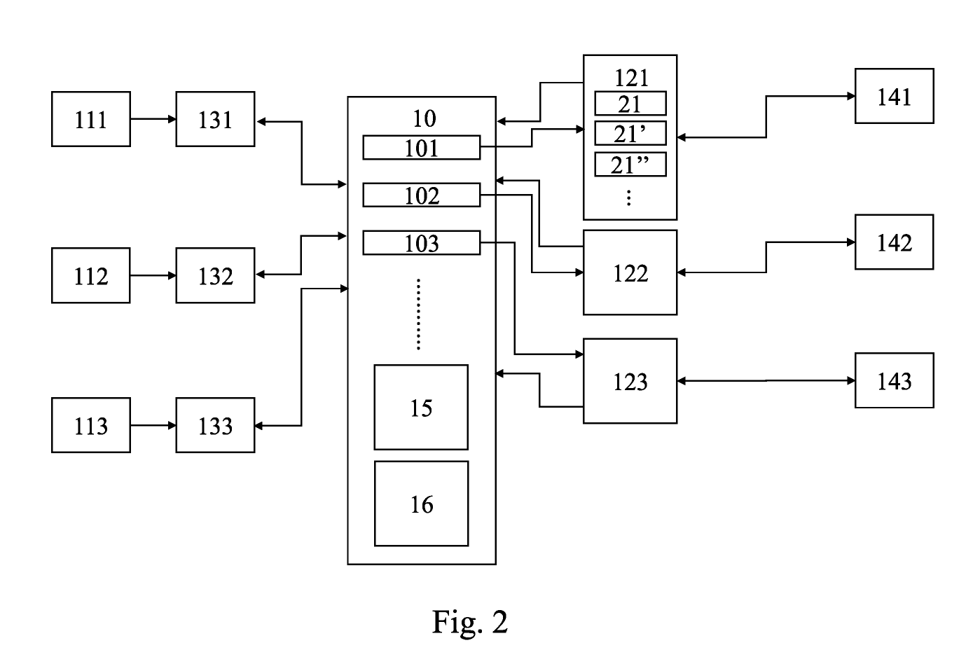

Referring to FIG. 2, the present invention may further include a search module 15 whereby the client-end users 111, 112, 113 can search for the client-end merchant(s) 141, 142, 143 that provide the desired services. In addition, the business mobile communication system of the present invention may include an online purchase module 16. Each client-end user 111, 112, 113 who has accessed the specific digital contents 21, 21′, 21″ and wishes to purchase online the services or products contained in the digital contents 21, 21′, 21″ can use the corresponding mobile communication device 131, 132, 133 to transmit a purchase order to the online purchase module 16 through the communication network. Upon receiving the purchase order placed by the client-end user 111, 112, 113, the transaction platform 10 transmits the purchase order via the Internet to the digital content server 121, 122, 123 (in this case, 121) that corresponds to the purchase order.

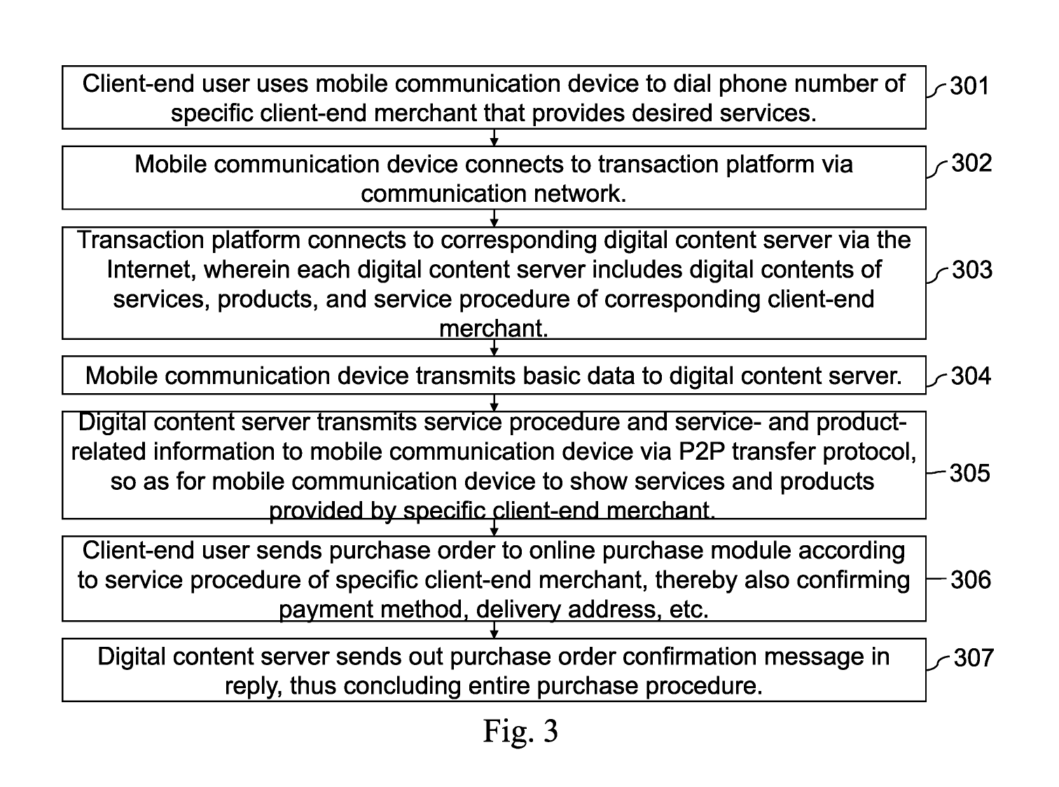

Referring to FIG. 3 in conjunction with FIG. 1, the steps for operating the disclosed business mobile communication system according to a first embodiment of the present invention are as follows:

(1) Step 301: A client-end user 111, 112, 113 uses the corresponding mobile communication device 131, 132, 133 to dial the phone number of a specific client-end merchant 141, 142, 143 that provides the desired services.

(2) Step 302: The mobile communication device 131, 132, 133 connects to the transaction platform 10 through the communication network.

(3) Step 303: The transaction platform 10 connects to the corresponding digital content server 121, 122, 123 via the Internet, wherein each of the digital content servers 121, 122, 123 includes digital contents of the services, products, and service procedure of the corresponding client-end merchant 141, 142, 143.

(4) Step 304: The mobile communication device 131, 132, 133 transmits basic data to the digital content server 121, 122, 123.

(5) Step 305: The digital content server 121, 122, 123 transmits the service procedure and service- and product-related information therein to the mobile communication device 131, 132, 133 via a point-to-point transfer protocol, so as for the mobile communication device 131, 132, 133 to show the services and products provided by the specific client-end merchant 141, 142, 143.

(6) Step 306: The client-end user 111, 112, 113 sends a purchase order to the online purchase module 16 according to the service procedure of the specific client-end merchant 141, 142, 143 and thereby also confirms such information as the payment method and the delivery address.

(7) Step 307: The digital content server 121, 122, 123 sends out a purchase order confirmation message in reply and thus concludes the entire purchase procedure.

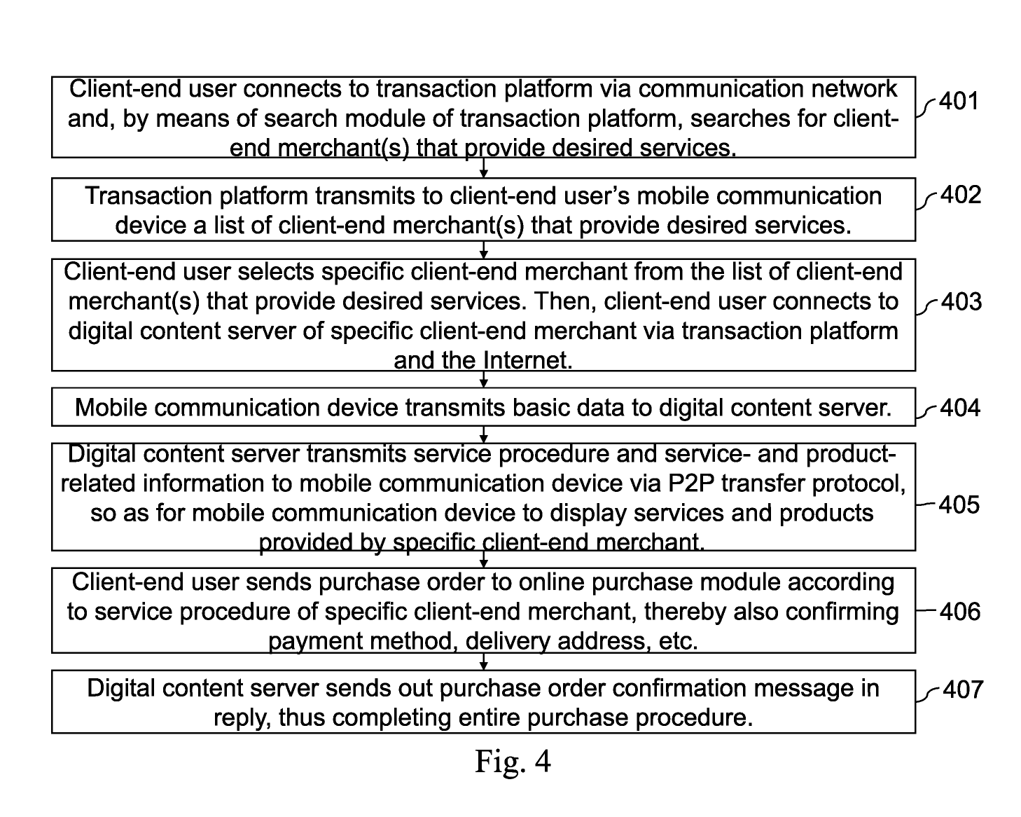

According to a second embodiment of the present invention, and referring to FIG. 4 in conjunction with FIG. 2, the disclosed business mobile communication system is operated by the following steps:

(1) Step 401: A client-end user 111, 112, 113 connects to the transaction platform 10 via the communication network and, by means of the search module 15 of the transaction platform 10, searches for the client-end merchant(s) 141, 142, 143 that provide the desired services, wherein the client-end merchants 141, 142, 143 correspond to the digital content servers 121, 122, 123, respectively.

(2) Step 402: The transaction platform 10 transmits to the client-end user 111, 112, 113′s mobile communication device 131, 132, 133 a list of the client-end merchant(s) 141, 142, 143 that provide the desired services.

(3) Step 403: The client-end user 111, 112, 113 selects a specific client-end merchant 141, 142, 143 (say 141) from the list of the client-end merchant(s) 141, 142, 143 that provide the desired services. Then, by way of the transaction platform 10 and the Internet, the client-end user 111, 112, 113 connects to the digital content server 121, 122, 123 (in this case, 121) of the specific client-end merchant 141, 142, 143 (in this case, 141).

(4) Step 404: The mobile communication device 131, 132, 133 transmits basic data to the digital content server 121, 122, 123 (in this case, 121).

(5) Step 405: The digital content server 121, 122, 123 (in this case, 121) transmits the service procedure and service- and product-related information therein to the mobile communication device 131, 132, 133 via a point-to-point transfer protocol, so as for the mobile communication device 131, 132, 133 to display the services and products provided by the specific client-end merchant 141, 142, 143 (in this case, 141).

(6) Step 406: The client-end user 111, 112, 113 sends a purchase order to the online purchase module 16 according to the service procedure of the specific client-end merchant 141, 142, 143 (in this case, 141), thereby also confirming such information as the payment method and the delivery address.

(7) Step 407: The digital content server 121, 122, 123 sends out a purchase order confirmation message in reply and thus completes the entire purchase procedure.

While the present invention is described herein by reference to the preferred embodiments, it is understood that the embodiments are not intended to limit the scope of the present invention. Moreover, as the contents disclosed herein should be readily understandable and can be implemented by a person skilled in the art, all equivalent changes or modifications which do not depart from the spirit of the present invention should be encompassed by the appended claims.

What is claimed is:

1. A business mobile communication system, comprising a transaction platform, a plurality of client-end users, and at least a digital content server, the business mobile communication system being characterized in that:
the business mobile communication system further comprises a communication network, the Internet, and a plurality of mobile communication devices, the mobile communication devices are for use by the client-end users respectively;
each said digital content server comprises multiple commerce-related digital contents;
the transaction platform comprises a content index of each said digital content server;
the communication network connects the transaction platform and the plural mobile communication devices;
the Internet connects the transaction platform and the at least a digital content server; and
each said client-end user can operate a corresponding said mobile communication device in a dialing number method and thereby connect the mobile communication device to the transaction platform via the communication network, and once authorized by the transaction platform, the client-end user can further connect the mobile communication device to any said digital content server through the Internet by way of a corresponding said content index in the transaction platform, so as to access a specific said digital content, wherein the specific digital content is transmitted to the client-end user's mobile communication device via a point-to-point transfer protocol.

2. The business mobile communication system of claim 1, further comprising a plurality of client-end merchants.

3. The business mobile communication system of claim 2, wherein there are a plurality of said digital content servers, and the client-end merchants correspond to the digital content servers respectively.

4. The business mobile communication system of claim 2, wherein the transaction platform further comprises a search module for searching for all said client-end merchants that provide a certain service.

5. The business mobile communication system of claim 2, wherein the transaction platform further comprises an online purchase module so that a said client-end user who has accessed a specific said digital content and wishes to purchase a service or product contained in the specific digital content can use a corresponding said mobile communication device to transmit a purchase order to the online purchase module via the communication network.

6. The business mobile communication system of claim 5, wherein upon receiving the purchase order sent by the client-end user, the transaction platform transmits the purchase order via the Internet to a said digital content server corresponding to the purchase order.
